(19) United States
(12) Patent Application Publication
(10) Pub. No.: US 2026/0362278 A1
(43) Pub. Date: Nov. 12, 2026

(54) HANDOVER MANAGEMENT IN RIS-ASSISTED WIRELESS NETWORKS

(71) Applicant: LENOVO (BEIJING) LIMITED, Beijing (CN)

(72) Inventors: Tingnan Bao, Beijing (CN); Jianfeng Wang, Beijing (CN); Haiming Wang, Beijing (CN); Lihua Yang, Beijing (CN)

(21) Appl. No.: 19/113,466

(22) PCT Filed: Oct. 14, 2022
(86) PCT No.: PCT/CN2022/125359

§ 371 Date: Mar. 20, 2025

(51) Int. Cl. H04W 36/30; H04B 7/04

(52) U.S. Cl. CPC H04W 36/304; H04B 7/04013

(57) ABSTRACT

Methods and apparatuses for handover management in re-configurable intelligent surface (RIS)-assisted wireless networks are disclosed. In one embodiment, a base station of a serving cell comprises a transceiver; and a processor coupled to the transceiver, wherein the processor is configured to compare, for a UE, the signal quality of the serving cell and the signal quality of a neighboring cell, wherein, a first RIS is deployed in the serving cell, and the signal quality of the serving cell is calculated by considering a direct link from the base station to the UE and a cascaded link from the base station via the first RIS to the UE; and switch the UE from the serving cell to the neighboring cell if the signal quality of the neighboring cell is better than the signal quality of the serving cell.

### FIELD

The subject matter disclosed herein generally relates to wireless communications, and more particularly relates to methods and apparatuses for handover management in re-configurable intelligent surface (RIS)-assisted wireless networks.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Reconfigurable Intelligent Surface (RIS), Large Intelligent Surface (LIS), Intelligent Reflecting Surface (IRS), line of sight (LOS), Non Line of Sight (NLOS), Industrial internet-of-things (IIoT), ultra-reliable and low-latency communication (URLLC), enhance mobile broadband (eMMB), massive machine-type communication (mMTC), transmission-reception point (TRP), handover (HO), Beyond 5G (B5 G), received signal received power (RSRP), signal to interference plus noise ratio (SINR), reference signal received quality (RSRQ).

Reconfigurable Intelligent Surface (RIS), which can be alternatively referred to as Large Intelligent Surface (LIS), Intelligent Reflecting Surface (IRS) or Intelligent Metasurface, is an emerging technology. RIS is a large and thin metasurface of metallic or dielectric material, comprised of an array of passive sub-wavelength scattering elements with specially designed physical structure. The elements can be controlled in a software-defined manner to change the electromagnetic (EM) properties (e.g., phase shift) of the reflection of the incident radio frequency (RF) signals. By a joint phase control of all scattering elements, the reflected radiation pattern of the incident RF signals can be arbitrarily tuned in real time, thus creating new degrees of freedom to the optimization of the overall wireless network performance. RIS can real-time control the response of electromagnetic wave effectively and is considered as one of the potential key technologies for 6G systems.

A typical deployment of RIS in a modern mobile communication system (e.g., RIS-aided URLLC system in a smart factory) is illustrated in FIG. 1, where the RIS (e.g., located on the wall or the ceiling of the smart factory) is controlled by a base station (BS), e.g., gNB or TRP, via a dedicated interface (note that the interface may be defined if the RIS is regarded as a new node category in 6G networks). The RIS forwards the signal from the BS to the target user equipment (UE), e.g., an automatic robot. That is, the RIS forms a cascaded link between the BS and the UE.

With the mobility of UEs, handover (HO) is an important part of the mobility management of the wireless cellular communication system. The success rate of the HO is an important consideration index of the mobility management performance of the wireless cellular communication system. The HO decision is mainly based on UE's measurement report of signal quality, e.g., the strength or quality of the received signal. The network may hand over (i.e., switch) the UE from the serving cell to a neighboring cell with a better signal quality, so the UE can obtain better radio conditions and a better user experience. Due to the new services in the 5G network, such as low latency and high-reliability performance, 5G NR needs a different design from the previous standard networks such as LTE. As such, the HO between cells will be more complicated and frequent for mobility enhancement to face these changing scenarios. In B5G (Beyond 5G) and 6G networks, the number of UEs is growing rapidly, and smart devices will also be widely used. Thus, an efficient HO management process is a major necessity.

Although RIS is a promising technology to alleviate the problems of traditional wireless networks, HO management remains an open challenge in B5G or 6G networks. Since RIS is passive, it can neither predict nor track the mobility of roaming UEs by sending pilot signals. The challenge is exacerbated in the absence of LoS (line of sight) or direct links between BSs and UEs due to obstacles or network sparsity. Therefore, mobility or HO management in RIS-assisted wireless networks is worth investigating. Besides, the HO management in RIS-assisted wireless networks can provide benefits for 6G standardization.

This invention targets HO management in RIS-assisted wireless networks.

### BRIEF SUMMARY

Methods and apparatuses for handover management in re-configurable intelligent surface (RIS)-assisted wireless networks are disclosed.

In one embodiment, a base station of a serving cell comprises a transceiver; and a processor coupled to the transceiver, wherein the processor is configured to compare, for a UE, the signal quality of the serving cell and the signal quality of a neighboring cell, wherein, a first RIS is deployed in the serving cell, and the signal quality of the serving cell is calculated by considering a direct link from the base station to the UE and a cascaded link from the base station via the first RIS to the UE; and switch the UE from the serving cell to the neighboring cell if the signal quality of the neighboring cell is better than the signal quality of the serving cell.

In some embodiment, the processor is further configured to turn OFF the first RIS if the UE is successfully switched to the neighboring cell.

In some embodiment, a second RIS is deployed in the neighboring cell controlled by a target base station, and the signal quality of the neighboring cell is calculated by considering a direct link from the target base station to the UE and a cascaded link from the target base station via the second RIS to the UE. In some embodiment, the processor is further configured to trigger the target base station to turn ON the second RIS. In some embodiment, the processor is further configured to receive, from the target base station, via the transceiver, the ON/OFF status of the second RIS.

In some embodiment, the processor is configured to compare, for a UE, the signal quality of the serving cell, the signal quality of a first neighboring cell controlled by a first target base station, and the signal quality of a second neighboring cell controlled by a second target base station, wherein, a second RIS is deployed in the first neighboring cell, and the signal quality of the first neighboring cell is calculated by only considering a direct link from the first target base station to the UE; and switch the UE from the serving cell to the first neighboring cell if the signal quality of the first neighboring cell is better than both the signal quality of the serving cell and the signal quality of the second neighboring cell. In some embodiment, the processor is further configured to trigger the first target base station to turn ON the second RIS if either the signal quality of the serving cell or the signal quality of the second neighboring cell is better than the signal quality of the first neighboring cell.

In some embodiment, the signal quality of the first neighboring cell is recalculated by considering both the direct link from the first target base station to the UE and a cascaded link from the first target base station via the second RIS to the UE, and the processor is further configured to re-compare, for the UE, the signal quality of the serving cell, the signal quality of the first neighboring cell, and the signal quality of the second neighboring cell, and switch the UE from the serving cell to the first neighboring cell if the signal quality of the first neighboring cell is better than both the signal quality of the serving cell and the signal quality of the second neighboring cell; switch the UE from the serving cell to the second neighboring cell if the signal quality of the second neighboring cell is better than both the signal quality of the serving cell and the signal quality of the first neighboring cell; and switch the UE from the serving cell to the first neighboring cell or the second neighboring cell if the signal quality of the first neighboring cell and the signal quality of the second neighboring cell are the same and better than the signal quality of the serving cell. In some embodiment, the processor is further configured to turn OFF the first RIS if the UE is successfully switched to either the first neighboring cell or the second neighboring cell; and trigger the first target base station to turn OFF the second RIS if the UE is successfully switched to the second neighboring cell.

In some embodiment, the processor is further configured to receive, from the first target base station, via the transceiver, the ON/OFF status of the second RIS.

In another embodiment, a method performed at a base station comprises: comparing, for a UE, the signal quality of the serving cell and the signal quality of a neighboring cell, wherein, a first RIS is deployed in the serving cell, and the signal quality of the serving cell is calculated by considering a direct link from the base station to the UE and a cascaded link from the base station via the first RIS to the UE; and switching the UE from the serving cell to the neighboring cell if the signal quality of the neighboring cell is better than the signal quality of the serving cell.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a typical deployment of RIS in a modern mobile communication system;

FIG. 2 illustrates a scenario according to a first embodiment;

FIG. 3 illustrates handover procedure according to the first embodiment;

FIG. 4 illustrates a scenario according to a second embodiment;

FIG. 5 illustrates handover procedure according to the second embodiment;

FIG. 6 illustrates a scenario according to a third embodiment;

FIG. 7 illustrates handover procedure according to the third embodiment;

FIG. 8 is a schematic flow chart diagram illustrating an embodiment of a method; and

FIG. 9 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

When a UE is in both the range of the serving cell and the range of at least one neighboring cell, if the signal quality of a neighboring cell (which is better than a predetermined threshold) is better than the signal quality of the serving cell, the UE can be switched (i.e., handed over) from the serving cell to the neighboring cell. A serving cell is controlled by a serving base station (e.g., serving gNB). Each neighboring cell is controlled by a neighboring base station (e.g., neighboring gNB). Since the UE is switched from the serving cell controlled by the serving base station to the neighboring cell controlled by the neighboring base station, the serving cell and the serving base station can be also referred to as source cell and source base station (e.g., source gNB), and the neighboring cell and the neighboring base station can be also referred to as target cell and target base station (e.g., target gNB).

In this disclosure, it is assumed that the source cell (i.e., serving cell) is a RIS-assisted cell. It means that a RIS (e.g., a first RIS, or RIS #1) is deployed in the source cell and can be controlled by the source gNB (i.e., serving gNB). To make simplification, it is assumed that one RIS is deployed in the source cell. In addition, it is assumed that the RIS described in this disclosure is a passive RIS (i.e., all elements in the RIS are passive elements). In the following description, RIS refers to passive RIS.

On the other hand, for each neighboring cell (i.e., each target cell), any number of RISs (i.e., any number of passive RISs) can be deployed. Each RIS deployed in a neighboring cell controlled by a neighboring gNB can be controlled by the neighboring gNB.

The air interface between gNB and RIS could be a known interface, e.g., Uu interface, if the RIS is regarded as a special UE, or a newly defined interface, if the RIS will be regarded as a new type of network node.

The gNB can control the RIS by a control message (e.g., an activation signal or a deactivation signal). The control message may include indications to change the ON or OFF status of each element of the RIS and the reflect coefficient setting. The RIS is in OFF status by default. It means that each element of the RIS is configured as OFF.

The signal quality can be represented by various parameters, e.g., RSRP (received signal received power), SINR (signal to interference plus noise ratio), RSRQ (reference signal received quality), etc. To make simplification, in the following description, it is assumed that UE obtains RSRP from the serving cell and each of the neighboring cells, as the signal quality.

As described above, one RIS can be deployed in the serving cell. So, UE can connect to the serving gNB via both a direct link (i.e., without the RIS) and a cascaded link (i.e., with the RIS). That is, the direct link is from the serving gNB directly to the UE, while the cascaded link is from the serving gNB via the RIS to the UE. RSRPₛ denotes the RSRP from the serving cell via the direct link (e.g., RIS is not turned ON); while RSRP_{s(new)} denotes the RSRP from the serving cell via both the direct link and cascaded link (e.g., RIS is turned ON).

For each neighboring cell, any number of RIS(s) can be deployed. It is assumed that only one RIS can be turned ON for a UE. So, RSRPₜ₁ denotes the RSRP from the neighboring cell via the direct link to the UE; while RSRP_{t1(new)} denotes the RSRP from the neighboring cell via both the direct link and cascaded link to the UE.

If no RIS is deployed in a neighboring cell, the neighboring cell is referred to as a conventional neighboring cell. RSRPₜ₂ denotes the RSRP from the conventional neighboring cell (i.e., only via the direct link) to the UE.

A first embodiment relates to handover scheme for a conventional neighboring cell.

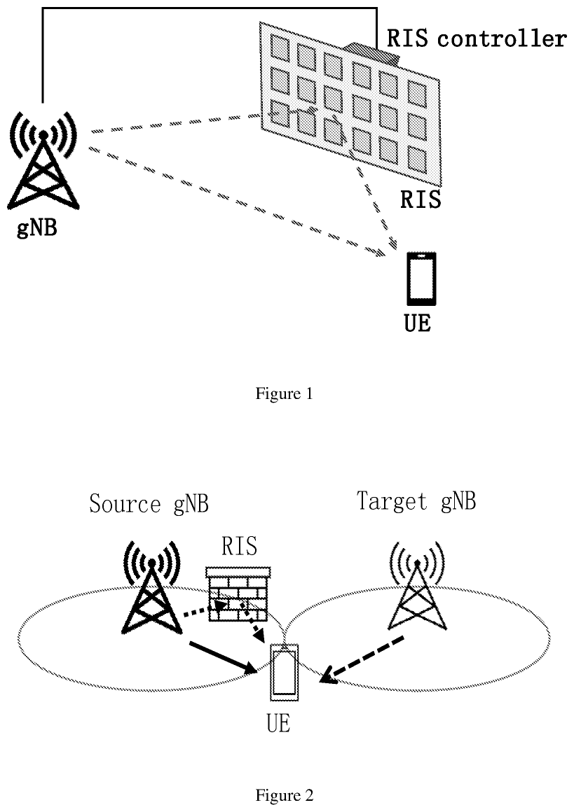

The first embodiment assumes a scenario in which UE hands over (i.e., switches) from a RIS-assisted serving cell controlled by a source gNB (i.e., a RIS is deployed in the serving cell and controlled by the source gNB) to a conventional neighboring cell controlled by a target gNB in which no RIS is deployed. As shown in FIG. 2, source gNB, target gNB, one RIS and one UE are included in this scenario. There is a direct link between source gNB and UE in the serving cell for communication (signal denoted in solid line). With UE mobility, UE can either switch to target gNB by performing handover (signal denoted in dashed line) or enhance the communication performance from source gNB by activating the cascaded link (denoted in dotted line).

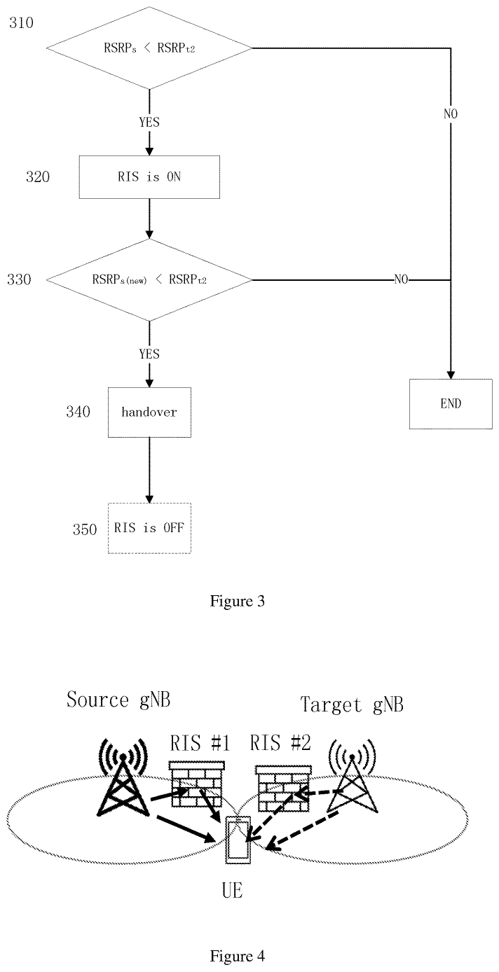

The handover procedure according to the first embodiment is illustrated in FIG. 3.

In step 310, RSRPₛ (the RSRP from the serving cell via the direct link to the UE) and RSRPₜ₂ (RSRP from the conventional neighboring cell to the UE) are measured at the UE and obtained by the source gNB from the UE. If RSRPₛ<RSRPₜ₂, the source gNB sends an activation signal to turn ON the RIS. Otherwise (e.g., RSRPₛ>=RSRPₜ₂), the procedure ends since handover is not necessary.

In the condition that the deployment of the RIS is available for the UE, RSRPₛ and RSRPₜ₂ can be compared at the UE. If RSRPₛ<RSRPₜ₂, the UE can turn ON the RIS or the UE can send an RIS activation request to the source gNB to turn ON the RIS. For the case that UE sends the RIS activation request to the source gNB, the source gNB may send an ACK message to the UE if the RIS can be turned ON, or gNB may send a NACK message to the UE if current interference situation is not allowed to turn ON the RIS. Alternatively, the source gNB may send a handover command to replace the NACK message.

The RIS is turned ON in step 320. The RIS will keep ON status until the “OFF” signal or deactivation signal is received. Alternatively, “ON” signal or activation signal can tell a smart RIS that how long the “ON” status will last. Accordingly, the smart RIS will automatically be turned OFF after a defined period.

In step 330, RSRP_{s(new)} (the RSRP from the serving cell via both the direct link and cascaded link to the UE) and RSRPₜ₂ are measured at the UE and obtained by the source gNB from the UE. If RSRP_{s(new)}<RSRPₜ₂, the source gNB can make handover decision in step 340. Otherwise (e.g., RSRP_{s(new)}>=RSRPₜ₂), the procedure ends since handover is not necessary.

Optionally, to mitigate interference from RIS, the source gNB in the serving cell may decide to send the deactivation signal to turn OFF the RIS (in step 350) after the handover succeeds. The source gNB may decide whether to switch OFF the RIS based on the information collected from the UE (e.g., the interference or load indication from the neighboring gNB).

A second embodiment relates to handover scheme for a RIS-assisted neighboring cell.

The second embodiment assumes a scenario in which UE hands over (i.e., switches) from a RIS-assisted serving cell controlled by a source gNB (i.e., a RIS is deployed in the serving cell and controlled by the source gNB) to a RIS-assisted neighboring cell controlled by a target gNB (i.e., at least one RIS is deployed in the neighboring cell and controlled by the target gNB). As shown in FIG. 4, source gNB, target gNB, RIS #1 controlled by the source gNB, RIS #2 controlled by the target gNB and one UE are included in this scenario. To make simplification, only one RIS (i.e., RIS #2) is deployed in the neighboring cell. If multiple RISs (including RIS #2) are deployed in the neighboring cell, it is assumed that RIS #2 is the RIS that can form a cascaded link between the UE and the target gNB.

As shown in FIG. 4, the received signals at UE consist of the direct signal coming from the source gNB and the reflected signal from the RIS #1 (signals denoted in solid lines). With UE mobility, UE can switch to the target gNB by performing handover into the RIS-assisted neighboring cell (signals denoted in dashed lines).

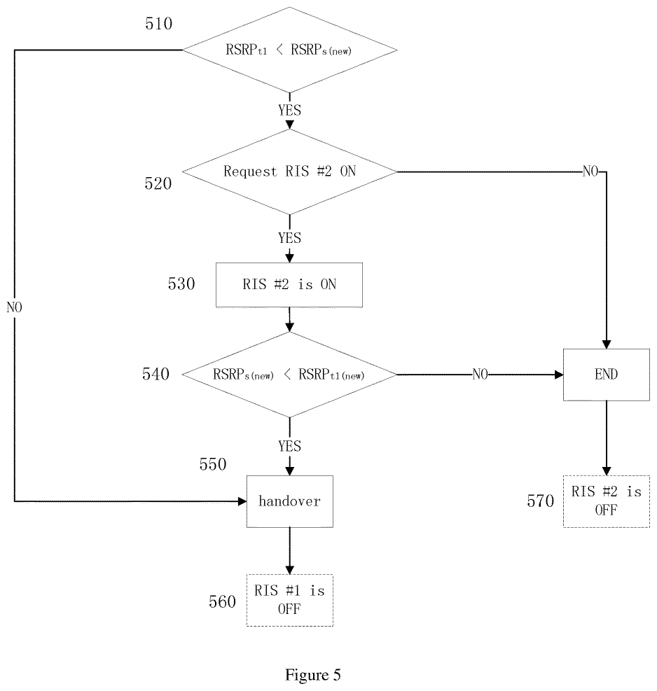

The handover procedure according to the second embodiment is illustrated in FIG. 5.

In step 510, RSRP_{s(new)} (the RSRP from the serving cell via both the direct link and cascaded link to the UE) and RSRPₜ₁ (the RSRP from the neighboring cell via the direct link to the UE) are measured at the UE and obtained by the source gNB from the UE.

If RSRPₜ₁<RSRP_{s(new)}, the source gNB may request a RIS deployed in the neighboring cell be turned ON in step 520.

Otherwise (e.g., RSRPₜ₁>=RSRP_{s(new)}), the source gNB can make handover decision.

It is expected that if the RIS deployed in the neighboring cell is turned ON, the signal quality of the neighboring cell will be better. The source gNB may send RIS ON Request message to the target gNB over Xn interface. Based on the received RIS ON Request message, the target gNB can send an activation signal to turn ON the RIS #2 in the neighboring cell and then send an ACK message to the source gNB to indicate that the RIS #2 is turned ON. If there are multiple RISs in the neighboring cell, the source gNB may send the RIS ON Request message with the detected RIS location (e.g., the location of the RIS #2) so that the target gNB knows which RIS is requested to be turned ON. When the RIS (e.g., RIS #2) is turned ON, the coefficients of the RIS #2 are tuned according to link estimation results from reference signals. The RIS #2 will keep ON status until the “OFF” signal or deactivation signal is received. Alternatively, “ON” signal or activation signal can tell a smart RIS that how long the “ON” status will last. Accordingly, the smart RIS will automatically be turned OFF after a defined period. Optionally, the target gNB may send the ON status of the RIS #2 (e.g., how long the ON status will last) to the source gNB.

If the RIS (e.g., RIS #2) deployed in the neighboring cell cannot be turned ON, the procedure ends. The target gNB may send a NACK message to the source gNB to indicate the failure of turning ON the RIS #2.

In step 530, the RIS #2 is turned ON. The cascaded link can be estimated at the target gNB to derive the optimal reflect coefficients for the UE.

In step 540, RSRP_{s(new)} and RSRP_{t1(new)} (the RSRP from the neighboring cell via both the direct link and cascaded link to the UE) are measured at the UE and obtained by the source gNB from the UE.

If RSRP_{s(new)}<RSRP_{t1(new)}, the source gNB can make handover decision in step 550. Optionally, to mitigate interference from RIS (e.g., RIS #1), the source gNB in the serving cell may decide to send the deactivation signal to turn OFF the RIS #1, in step 560.

Otherwise (e.g., RSRP_{s(new)}>=RSRP_{t1(new)}), the procedure ends since handover is not necessary. Optionally, to mitigate interference from the RIS #2, the source gNB may, based on the information collected from the UE, request the target gNB turn OFF the RIS #2 in step 570. For example, if a RIS OFF message is obtained from the source gNB via Xn interface, the target gNB may send a deactivation signal to turn OFF the RIS #2 in the neighboring cell.

A third embodiment relates to HO scheme for multiple neighboring cells.

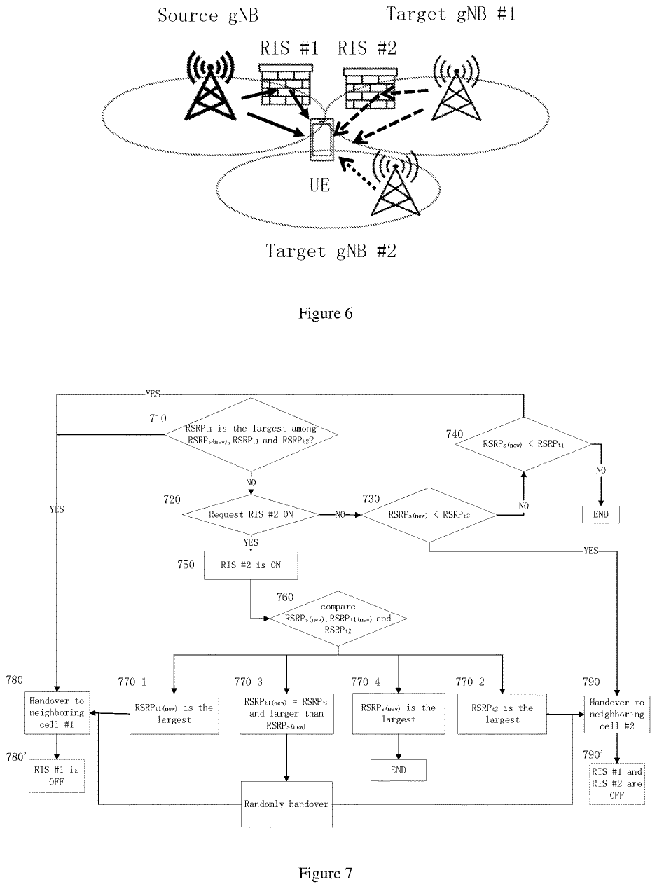

The third embodiment assumes a scenario in which UE hands over (i.e., switches) from a RIS-assisted serving cell controlled by a source gNB (i.e., a RIS is deployed in the serving cell and controlled by the source gNB) to one of its neighboring cells, e.g., a RIS-assisted neighboring cell controlled by target gNB #1 (i.e., at least one RIS is deployed in the RIS-assisted neighboring cell and controlled by the target gNB #1) and a conventional neighboring cell controlled by target gNB #2 in which no RIS is deployed. As shown in FIG. 6, source gNB, RIS #1 controlled by the source gNB, target gNB #1, RIS #2 controlled by the target gNB #1, target gNB #2 and one UE are included in this scenario. To make simplification, only one RIS (i.e., RIS #2) is deployed in the RIS-assisted neighboring cell. In the following description, the RIS-assisted neighboring cell controlled by the target gNB #1 may be referred to as neighboring cell #1, and the conventional neighboring cell controlled by the target gNB #2 may be referred to as neighboring cell #2.

As shown in FIG. 6, the received signals at UE consist of the direct signal coming from the source gNB and the reflected signal from the RIS #1 (signals denoted in solid line). With UE mobility, UE can switch to one of the target gNB #1 and the target gNB #2 by performing handover into the neighboring cell #1 (signals denoted in dashed line) or the neighboring cell #2 (signals denoted in dotted line).

The handover procedure according to the third embodiment is illustrated in FIG. 7.

In step 710, RSRP_{s(new)} (the RSRP from the serving cell via both the direct link and cascaded link to the UE), RSRPₜ₁ (the RSRP from the neighboring cell #1 via the direct link to the UE) and RSRPₜ₂ (the RSRP from the neighboring cell #2 to the UE) are measured at the UE and obtained by the source gNB from the UE.

If RSRPₜ₁ is the largest among RSRP_{s(new)}, RSRPₜ₁, and RSRPₜ₂, the source gNB can make handover decision to handover to the neighboring cell #1, in step 780.

If RSRPₜ₁ is not the largest among RSRP_{s(new)}, RSRPₜ₁, and RSRPₜ₂, the source gNB may request a RIS (e.g., RIS #2) deployed in the neighboring cell #1 be turned ON in step 720. The source gNB may send a RIS ON Request message to the target gNB #1 over Xn interface. Based on the received RIS ON Request message, the target gNB #1 can send an activation signal to turn ON RIS #2 in the neighboring cell #1 and then send an ACK message to the source gNB to indicate that the RIS #2 is turned ON. When the RIS #2 is turned ON, the coefficients of the RIS #2 are tuned according to the link estimation results from the reference signals. In addition, the target gNB #2 may send the ON status of the RIS #2 (e.g., how long the ON status will last) to the source gNB.

If the RIS #2 deployed in the neighboring cell #1 cannot be turned ON, RSRP_{s(new)} is compared with RSRPₜ₂ in step 730. If RSRP_{s(new)}<RSRPₜ₂, the source gNB can make handover decision to handover to the neighboring cell #2, in step 790. Otherwise (e.g., RSRP_{s(new)}>=RSRPₜ₂), RSRP_{s(new)} is compared with RSRPₜ₁ in step 740. If RSRP_{s(new)}<RSRPₜ₁, the source gNB can make handover decision to handover to the neighboring cell #1. Otherwise (e.g., RSRP_{s(new)}>=RSRPₜ₁), the procedure ends since handover is not necessary.

In step 750, the RIS #2 is turned ON. The cascaded link can be estimated at the target gNB #1 to derive the optimal reflect coefficients of the RIS #2 for the UE.

In step 760, RSRP_{s(new)}, RSRP_{t1(new)}, and RSRPₜ₂ are compared.

Four different comparison results may happen.

If RSRP_{t1(new)} is the largest among RSRP_{s(new)}, RSRP_{t1(new)}, and RSRPₜ₂ (step 770-1), the source gNB can make handover decision to handover the UE to the neighboring cell #1, in step 780.

If RSRPₜ₂ is the largest among RSRP_{s(new)}, RSRP_{t1(new)}, and RSRPₜ₂ (step 770-2), the source gNB can make handover decision to handover the UE to the neighboring cell #2, in step 790.

Incidentally, it is possible that RSRP_{t1(new)}=RSRPₜ₂. In this condition, if RSRP_{t1(new)}=RSRPₜ₂>RSRP_{s(new)} (step 770-3), the source gNB can make handover decision to randomly handover to the neighboring cell #1 (in step 780) or the neighboring cell #2 (in step 790).

If RSRP_{s(new)} is the largest among RSRP_{s(new)}, RSRP_{t1(new)}, and RSRPₜ₂ (step 770-4), the procedure ends since handover is not necessary.

When the UE is successfully switched to the neighboring cell #1, the RIS #1 can be optionally turned OFF in step 780′.

When the UE is successfully switched to the neighboring cell #2, the RIS #1 can be optionally turned OFF. In addition, the RIS #2, if being in the status of “ON”, shall also be optionally turned OFF in step 790′.

The turning OFF of the RIS #1 and/or the RIS #2 can be based on the information collected from the UE.

In all of the above embodiments, one RSRP being lower than another RSRP (e.g., RSRP_{s(new)} being lower than RSRP_{t1(new)}) means that RSRP_{s(new)}<RSRP_{t1(new)}. Alternatively, one RSRP being lower than another RSRP (e.g., RSRP_{s(new)} being lower than RSRP_{t1(new)}) may mean the one RSRP is offset lower than the other RSRP. For example, RSRP_{s(new)} being lower than RSRP_{t1(new)} may mean RSRP_{s(new)}+offset<RSRP_{t1(new)}, where offset is a predetermined value. Similarly, one RSRP being higher than another RSRP may mean that the one RSRP is offset higher than the other RSRP. For example, RSRP_{s(new)} being higher than RSRP_{t1(new)} may mean RSRP_{s(new)}+offset>RSRP_{t1(new)}.

As a whole, the signal quality of one cell is better than the signal quality of another cell may mean the RSRP (or RSRQ or SINR) of the one cell is larger than that of the other cell or is offset larger than that of the other cell.

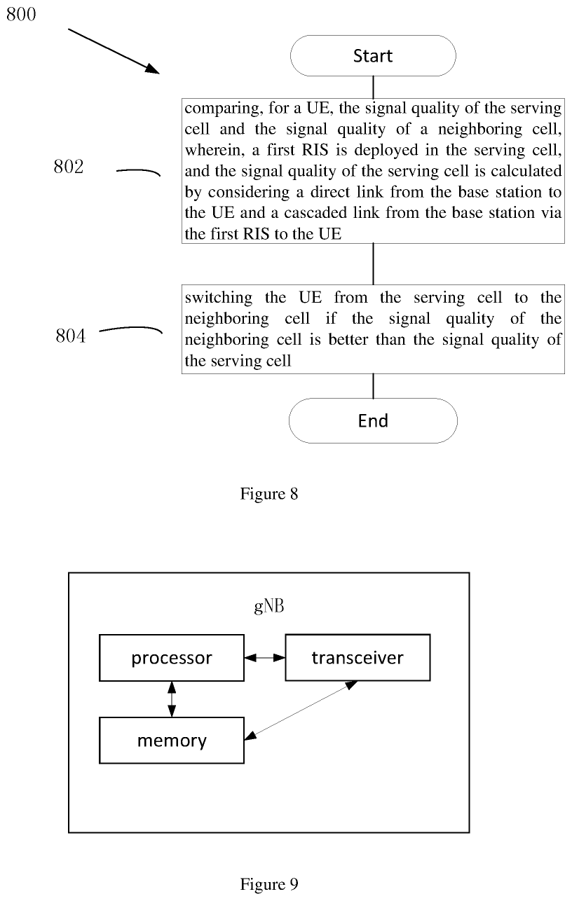

FIG. 8 is a schematic flow chart diagram illustrating an embodiment of a method 800 according to the present application. In some embodiments, the method 800 is performed by an apparatus, such as a base station of a serving cell. In certain embodiments, the method 800 may be performed by a processor executing program code, for example, a microcontroller, a microprocessor, a CPU, a GPU, an auxiliary processing unit, a FPGA, or the like.

The method 800 may include 802 comparing, for a UE, the signal quality of the serving cell and the signal quality of a neighboring cell, wherein, a first RIS is deployed in the serving cell, and the signal quality of the serving cell is calculated by considering a direct link from the base station to the UE and a cascaded link from the base station via the first RIS to the UE; and 804 switching the UE from the serving cell to the neighboring cell if the signal quality of the neighboring cell is better than the signal quality of the serving cell.

In some embodiment, the method further comprises turning OFF the first RIS if the UE is successfully switched to the neighboring cell.

In some embodiment, a second RIS is deployed in the neighboring cell controlled by a target base station, and the signal quality of the neighboring cell is calculated by considering a direct link from the target base station to the UE and a cascaded link from the target base station via the second RIS to the UE. In some embodiment, the method further comprises: triggering the target base station to turn ON the second RIS. In addition, the method further comprising: receiving, from the target base station, the ON/OFF status of the second RIS.

In some embodiment, the method comprises: comparing, for a UE, the signal quality of the serving cell, the signal quality of a first neighboring cell controlled by a first target base station, and the signal quality of a second neighboring cell controlled by a second target base station, wherein, a second RIS is deployed in the first neighboring cell, and the signal quality of the first neighboring cell is calculated by only considering a direct link from the first target base station to the UE; and switching the UE from the serving cell to the first neighboring cell if the signal quality of the first neighboring cell is better than both the signal quality of the serving cell and the signal quality of the second neighboring cell. In some embodiment, the method further comprises triggering the first target base station to turn ON the second RIS if either the signal quality of the serving cell or the signal quality of the second neighboring cell is better than the signal quality of the first neighboring cell.

In some embodiment, the signal quality of the first neighboring cell is recalculated by considering both the direct link from the first target base station to the UE and a cascaded link from the first target base station via the second RIS to the UE, and the method further comprises re-comparing, for the UE, the signal quality of the serving cell, the signal quality of the first neighboring cell, and the signal quality of the second neighboring cell, and switching the UE from the serving cell to the first neighboring cell if the signal quality of the first neighboring cell is better than both the signal quality of the serving cell and the signal quality of the second neighboring cell; switching the UE from the serving cell to the second neighboring cell if the signal quality of the second neighboring cell is better than both the signal quality of the serving cell and the signal quality of the first neighboring cell; and switching the UE from the serving cell to the first neighboring cell or the second neighboring cell if the signal quality of the first neighboring cell and the signal quality of the second neighboring cell are the same and better than the signal quality of the serving cell. In some embodiment, the method further comprises turning OFF the first RIS if the UE is successfully switched to either the first neighboring cell or the second neighboring cell; and triggering the first target base station to turn OFF the second RIS if the UE is successfully switched to the second neighboring cell.

In some embodiment, the method further comprises receiving, from the first target base station, the ON/OFF status of the second RIS.

FIG. 9 is a schematic block diagram illustrating apparatuses according to one embodiment.

Referring to FIG. 9, the base station (e.g., gNB) includes a processor, a memory, and a transceiver that is a transmitter and/or a receiver. The processors implement a function, a process, and/or a method which are proposed in FIG. 8.

The base station comprises a transceiver; and a processor coupled to the transceiver, wherein the processor is configured to compare, for a UE, the signal quality of the serving cell and the signal quality of a neighboring cell, wherein, a first RIS is deployed in the serving cell, and the signal quality of the serving cell is calculated by considering a direct link from the base station to the UE and a cascaded link from the base station via the first RIS to the UE; and switch the UE from the serving cell to the neighboring cell if the signal quality of the neighboring cell is better than the signal quality of the serving cell.

In some embodiment, the processor is further configured to turn OFF the first RIS if the UE is successfully switched to the neighboring cell.

In some embodiment, a second RIS is deployed in the neighboring cell controlled by a target base station, and the signal quality of the neighboring cell is calculated by considering a direct link from the target base station to the UE and a cascaded link from the target base station via the second RIS to the UE. In some embodiment, the processor is further configured to trigger the target base station to turn ON the second RIS. In some embodiment, the processor is further configured to receive, from the target base station, via the transceiver, the ON/OFF status of the second RIS.

In some embodiment, the processor is configured to compare, for a UE, the signal quality of the serving cell, the signal quality of a first neighboring cell controlled by a first target base station, and the signal quality of a second neighboring cell controlled by a second target base station, wherein, a second RIS is deployed in the first neighboring cell, and the signal quality of the first neighboring cell is calculated by only considering a direct link from the first target base station to the UE; and switch the UE from the serving cell to the first neighboring cell if the signal quality of the first neighboring cell is better than both the signal quality of the serving cell and the signal quality of the second neighboring cell. In some embodiment, the processor is further configured to trigger the first target base station to turn ON the second RIS if either the signal quality of the serving cell or the signal quality of the second neighboring cell is better than the signal quality of the first neighboring cell.

In some embodiment, the signal quality of the first neighboring cell is recalculated by considering both the direct link from the first target base station to the UE and a cascaded link from the first target base station via the second RIS to the UE, and the processor is further configured to re-compare, for the UE, the signal quality of the serving cell, the signal quality of the first neighboring cell, and the signal quality of the second neighboring cell, and switch the UE from the serving cell to the first neighboring cell if the signal quality of the first neighboring cell is better than both the signal quality of the serving cell and the signal quality of the second neighboring cell; switch the UE from the serving cell to the second neighboring cell if the signal quality of the second neighboring cell is better than both the signal quality of the serving cell and the signal quality of the first neighboring cell; and switch the UE from the serving cell to the first neighboring cell or the second neighboring cell if the signal quality of the first neighboring cell and the signal quality of the second neighboring cell are the same and better than the signal quality of the serving cell. In some embodiment, the processor is further configured to turn OFF the first RIS if the UE is successfully switched to either the first neighboring cell or the second neighboring cell; and trigger the first target base station to turn OFF the second RIS if the UE is successfully switched to the second neighboring cell.

In some embodiment, the processor is further configured to receive, from the first target base station, via the transceiver, the ON/OFF status of the second RIS.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A base station of a serving cell, comprising:
at least one memory; and
at least one processor coupled with the at least one memory and configured to cause the base station to:
compare, for a user equipment (UE), a signal quality of the serving cell and a signal quality of a neighboring cell, wherein a first reconfigurable intelligent surface (RIS) RIS is deployed in the serving cell, and the signal quality of the serving cell is calculated by considering a direct link from the base station to the UE and a cascaded link from the base station via the first RIS to the UE; and
switch the UE from the serving cell to the neighboring cell if the signal quality of the neighboring cell is better than the signal quality of the serving cell.

2. The base station of claim 1, wherein the at least one processor is configured to cause the base station to turn OFF the first RIS if the UE is successfully switched to the neighboring cell.

3. The base station of claim 1, wherein a second RIS is deployed in the neighboring cell controlled by a target base station, and the signal quality of the neighboring cell is calculated by considering a direct link from the target base station to the UE and a cascaded link from the target base station via the second RIS to the UE.

4. The base station of claim 3, wherein the at least one processor is configured to cause the base station to trigger the target base station to turn ON the second RIS.

5. The base station of claim 4, wherein the at least one processor is configured to cause the base station to receive, from the target base station, an ON/OFF status of the second RIS.

6. The base station of claim 1, wherein the at least one processor is configured to cause the base station to:
compare, for the UE, the signal quality of the serving cell, a signal quality of a first neighboring cell controlled by a first target base station, and a signal quality of a second neighboring cell controlled by a second target base station, wherein a second RIS is deployed in the first neighboring cell, and the signal quality of the first neighboring cell is calculated by only considering a direct link from the first target base station to the UE; and
switch the UE from the serving cell to the first neighboring cell if the signal quality of the first neighboring cell is better than both the signal quality of the serving cell and the signal quality of the second neighboring cell.

7. The base station of claim 6, wherein the at least one processor is configured to cause the base station to trigger the first target base station to turn ON the second RIS if either the signal quality of the serving cell or the signal quality of the second neighboring cell is better than the signal quality of the first neighboring cell.

8. The base station of claim 7, wherein the signal quality of the first neighboring cell is recalculated by considering both the direct link from the first target base station to the UE and a cascaded link from the first target base station via the second RIS to the UE, and
the at least one processor is further configured to cause the base station to re-compare, for the UE, the signal quality of the serving cell, the signal quality of the first neighboring cell, and the signal quality of the second neighboring cell, and
switch the UE from the serving cell to the first neighboring cell if the signal quality of the first neighboring cell is better than both the signal quality of the serving cell and the signal quality of the second neighboring cell;
switch the UE from the serving cell to the second neighboring cell if the signal quality of the second neighboring cell is better than both the signal quality of the serving cell and the signal quality of the first neighboring cell; and
switch the UE from the serving cell to the first neighboring cell or the second neighboring cell if the signal quality of the first neighboring cell and the signal quality of the second neighboring cell are the same and better than the signal quality of the serving cell.

9. The base station of claim 8, wherein the at least one processor is configured to cause the base station to:
turn OFF the first RIS if the UE is successfully switched to either the first neighboring cell or the second neighboring cell; and
trigger the first target base station to turn OFF the second RIS if the UE is successfully switched to the second neighboring cell.

10. The base station of claim 7, wherein the at least one processor is further configured to cause the base station to receive, from the first target base station, via an ON/OFF status of the second RIS.

11. A method performed at a base station of a serving cell, the method comprising:
comparing, for a user equipment (UE), a signal quality of the serving cell and a signal quality of a neighboring cell, wherein, a first reconfigurable intelligent surface (RIS) is deployed in the serving cell, and the signal quality of the serving cell is calculated by considering a direct link from the base station to the UE and a cascaded link from the base station via the first RIS to the UE; and
switching the UE from the serving cell to the neighboring cell if the signal quality of the neighboring cell is better than the signal quality of the serving cell.

12. The method of claim 11, wherein a second RIS is deployed in the neighboring cell controlled by a target base station, and the signal quality of the neighboring cell is calculated by considering a direct link from the target base station to the UE and a cascaded link from the target base station via the second RIS to the UE.

13. The method of claim 11, comprising:
comparing, for the UE, the signal quality of the serving cell, a signal quality of a first neighboring cell controlled by a first target base station, and signal quality of a second neighboring cell controlled by a second target base station, wherein, a second RIS is deployed in the first neighboring cell, and the signal quality of the first neighboring cell is calculated by only considering a direct link from the first target base station to the UE; and
switching the UE from the serving cell to the first neighboring cell if the signal quality of the first neighboring cell is better than both the signal quality of the serving cell and the signal quality of the second neighboring cell.

14. The method of claim 13, further comprising triggering the first target base station to turn ON the second RIS if either the signal quality of the serving cell or the signal quality of the second neighboring cell is better than the signal quality of the first neighboring cell.

15. The method of claim 11, wherein the signal quality of the first neighboring cell is recalculated by considering both the direct link from a first target base station to the UE and a cascaded link from the first target base station via a second RIS to the UE, and the method further comprising:
re-comparing, for the UE, the signal quality of the serving cell, the signal quality of the first neighboring cell, and the signal quality of a second neighboring cell, and
switching the UE from the serving cell to the first neighboring cell if the signal quality of the first neighboring cell is better than both the signal quality of the serving cell and the signal quality of the second neighboring cell;
switching the UE from the serving cell to the second neighboring cell if the signal quality of the second neighboring cell is better than both the signal quality of the serving cell and the signal quality of the first neighboring cell; and
switching the UE from the serving cell to the first neighboring cell or the second neighboring cell if the signal quality of the first neighboring cell and the signal quality of the second neighboring cell are the same and better than the signal quality of the serving cell.

16. A processor for wireless communication in a serving cell, comprising:
at least one controller coupled with at least one memory and configured to cause the processor to:
compare, for a user equipment (UE), a signal quality of the serving cell and a signal quality of a neighboring cell, wherein a first reconfigurable intelligent surface (RIS) is deployed in the serving cell, and the signal quality of the serving cell is calculated by considering a direct link from the processor to the UE and a cascaded link from the processor via the first RIS to the UE; and
switch the UE from the serving cell to the neighboring cell if the signal quality of the neighboring cell is better than the signal quality of the serving cell.

17. The processor of claim 16, wherein the at least one controller is configured to cause the processor to turn OFF the first RIS if the UE is successfully switched to the neighboring cell.

18. The processor of claim 16, wherein a second RIS is deployed in the neighboring cell controlled by a target base station, and the signal quality of the neighboring cell is calculated by considering a direct link from the target base station to the UE and a cascaded link from the target base station via the second RIS to the UE.

19. The processor of claim 18, wherein the at least one controller is configured to cause the processor to trigger the target base station to turn ON the second RIS.

20. The processor of claim 19, wherein the at least one controller is configured to cause the processor to receive, from the target base station, an ON/OFF status of the second RIS.
